(19) United States
(12) Patent Application Publication
(10) Pub. No.: US 2022/0021691 A1
(43) Pub. Date: Jan. 20, 2022

(54) CREATION OF GENERALIZED CODE TEMPLATES TO PROTECT WEB APPLICATION COMPONENTS

(71) Applicant: Tala Security, Inc., Fremont, CA (US)

(72) Inventors: Sandeep Bhatkar, Sunnyvale, CA (US); Nicholas Maxwell, Covington, WA (US); Aditya Kumar, Siliguri (IN); Siddhesh Yawalkar, Sunnyvale, CA (US); Nhan Nguyen, Newark, CA (US); Ravi Bajpai, Kanpur (IN); Swapnil Bhalode, Fremont, CA (US); Hemant Puri, Fremont, CA (US)

(73) Assignee: Tala Security, Inc., Fremont, CA (US)

(21) Appl. No.: 17/375,419

(22) Filed: Jul. 14, 2021

Related U.S. Application Data
(60) Provisional application No. 63/051,842, filed on Jul. 14, 2020.

(51) Int. Cl. H04L 29/06

(52) U.S. Cl. CPC H04L 63/1416; H04L 63/1466; H04L 63/102; H04L 63/20; H04L 63/168

(57) ABSTRACT

Techniques to facilitate protection of web application components are disclosed herein. In at least one implementation, a plurality of web resources associated with a web applications is received. The plurality of web resources is processed to generate individual generalized code templates for each of the web resources by removing data constants and code formatting elements from the web resources. A set of the individual generalized code templates for each of the web resources is stored in a probabilistic data structure. A security web module comprising the probabilistic data structure having the set of the individual generalized code templates for each of the web resources stored therein is deployed to protect the web application.

### RELATED APPLICATIONS

This application claims the benefit of, and priority to, U.S. Provisional Patent Application No. 63/051,842, entitled “Efficient protection of web application scripts to prevent Cross-Site Scripting attacks”, filed on Jul. 14, 2020, which is hereby incorporated by reference in its entirety for all purposes.

### TECHNICAL BACKGROUND

Application-layer attacks are a major vulnerability of the security industry and are one of the largest sources of data breaches. Application-layer attacks exploit vulnerabilities within an application as well as susceptible components and unsecure coding practices used in building the application. Existing methodologies to protect an application rely on analysis techniques to identify already-published or known bugs and vulnerabilities, and then either requiring the application software developers to fix those bugs and remove the vulnerabilities in the application code, or generating virtual patches that can be configured on network firewalls and intrusion prevention systems to prevent the exploitation of those vulnerabilities. However, this blacklist approach, which attempts to prevent known malicious users, code, or inputs from reaching the application, offers inadequate protection because it only protects against attack vectors and vulnerabilities that have been previously discovered.

Modern web applications integrate code and resources from dozens of third-party service providers, including content delivery networks (CDNs) and third-party JavaScript libraries, and may range in function from user analytics to marketing tags, among other examples. Recent studies have found that almost two thirds of the content and code at websites is loaded from third parties. A significant portion of this content comprises executable scripts with direct security impact on a website. A greater security risk is due to the way in which many advertising platforms are set up, where the advertising host sites may not even be aware of which servers are placing content on the website. In the absence of proper vetting for third-party executable content, these web resources may be compromised or malicious. Many recent examples of crypto-jacking attacks have transpired involving a third-party library serving crypto-mining code to users from thousands of websites. In addition, recent breaches of user data on many popular websites have been attributed to compromised third-party JavaScript files.

### OVERVIEW

Techniques to facilitate protection of web application components are disclosed herein. In at least one implementation, a plurality of web resources associated with a web application is received. The plurality of web resources is processed to generate individual generalized code templates for each of the web resources by removing data constants and code formatting elements from the web resources. A set of the individual generalized code templates for each of the web resources is stored in a probabilistic data structure. A security web module comprising the probabilistic data structure having the set of the individual generalized code templates for each of the web resources stored therein is deployed to protect the web application.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates a communication system.

FIG. 2 is a flow diagram that illustrates an operation of the communication system.

FIG. 3 is a block diagram that illustrates an operation of a communication system in an exemplary embodiment.

FIG. 4 is a block diagram that illustrates an operation of a communication system in an exemplary embodiment.

FIG. 5 is a sequence diagram that illustrates an operation of a communication system in an exemplary embodiment.

FIG. 6 is a block diagram that illustrates a computing system.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Content security policy (CSP) is a widely supported web standard for preventing cross-site scripting (XSS) and code injection attacks. CSP provides a mechanism for website owners to specify the origins of allowed executable scripts and other code on their website, such as JavaScript content and other web resources. For example, JavaScript code can be loaded as an inline script, or through a uniform resource locator (URL) to an external first or third party script source. Unfortunately, the existing methods for specifying allowed scripts are often too coarse-grained, such as using URL or domain names, and adding nonce attributes in the script hypertext markup language (HTML) elements. This can lead to false negatives where a rogue script under an attacker's control can remain undetected, thereby compromising the security of the web application. Another more fine-grained security mechanism is called subresource integrity (SRI), which allows for greater precision in specifying the content of allowed scripts. For example, by specifying what resources a website depends on along with their approved origins and security hashes, SRI can be used to validate web resources provided by third parties, such as advertisers, CDNs, and other third-party services. However, this technique can lead to false positives when new benign scripts and other resources are generated from code templates. For example, it is fairly common practice to use such code templates to automatically generate scripts with the same code and functionality, but with different embedded application-specific data. Another difficulty is that application developers often create some benign changes in a script, but because these changes are not reflected in the security policy, then the script gets blocked by the policy. Unfortunately, this is a case of a false positive where a benign script is now flagged as malicious and is not allowed to run, which breaks the utility or use of the application. The present disclosure describes a practical enforcement approach that provides precise control over web application resources while still allowing for benign code variations, which helps in maintaining the security of the web applications without adversely affecting their utility.

One technique to address this problem involves generating abstract syntax tree (AST) templates from scripts seen during a training period, and requires parsing JavaScript code, extracting its AST representation, and finally generating its generalized form as an AST template. As part of the generalization, data nodes in the AST are represented by their type (e.g., string, integer, etc.) but without the actual values. At the enforcement time, any script that conforms to one of the known AST templates is allowed to run. However, this approach has a few critical issues. First, it requires language-dependent, version-specific parsing of JavaScript code, which is an expensive operation in terms of runtime performance. Second, the AST template generation approach fails whenever there is a syntax error in the script. Note that such a script can often still run successfully in the web browser because the execution may never reach the error part of the script. Even in presence of the error, the script can run fully or at least partially depending on the type of the error and whether the runtime interpreter tolerates the error. Third, the template representation in the form of a generalized AST requires substantial storage and memory overheads. Finally, new AST templates must be generated during enforcement in order to compare the scripts being loaded by a client web browser visiting a webpage to the known-valid AST templates generated during the training period, which is a very expensive operation that requires a lot of processing power and causes performance degradation of the website. The present disclosure provides a practical solution to address these and other concerns.

The techniques disclosed herein describe an efficient algorithm to generate generalized code templates for any type of web resources, such as JavaScript files, code libraries, style sheets, plugins, scripts, and any other components used in construction of a modern web application. The algorithm also provides a language-independent representation of a code template for a web resource. To generate the templates, web resources associated with a web application are processed to remove data constants and code formatting elements. The resulting templates are stored in a space-efficient probabilistic data structure to represent large amounts of templates. Enforcement is typically performed via a security web module that is deployed to protect the web application. Various deployment scenarios of protecting web resources in a web application are possible for the security web module, in that the module can be specific to the web application platform, such as a web server, middleware, reverse proxy, load balancer, CDN, and even at the client browser. Upon receiving a request for the web application from a client, the security web module operates to match new web resources against the known templates stored in the probabilistic data structure to check for membership. If the resource belongs to the known templates in the probabilistic data structure, the resource is protected using directives such as nonce and SRI. Otherwise, the web resource may be blocked by not using the directive or simply removing it from the web application, among other mitigation techniques.

Beneficially, the security techniques disclosed herein provide a language-agnostic approach by focusing purely on the data representation, while incurring low runtime and memory overhead. The templates that are generated capture generalized representations of web resource code in a language-independent manner, even if there are syntax errors or the implementation language of the code changes. Additionally, the algorithm is designed to allow unknown web resources that are benign variations of known resources, which are necessary to run to preserve the utility of the web application, without negatively impacting security. Further, memory usage is an issue because the templates have to be stored in memory for matching purposes, which can increase the memory requirements substantially when scaled up to a large number of web resources. Accordingly, storage of a multitude of templates is achieved through a memory-efficient probabilistic data structure, which provides an efficient membership check to determine whether a web resource is known and therefore benign or unknown and thus possibly malicious.

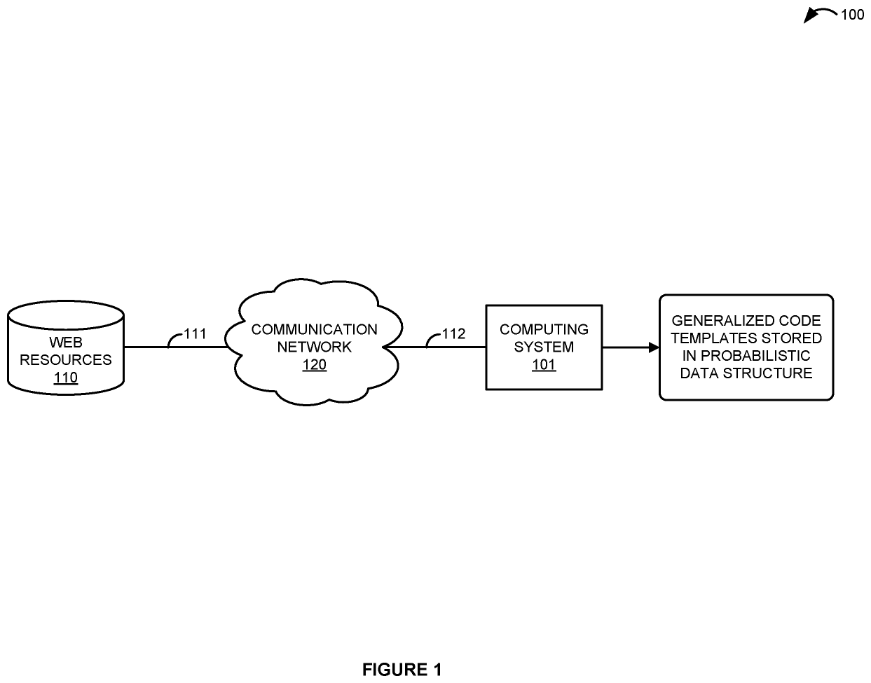

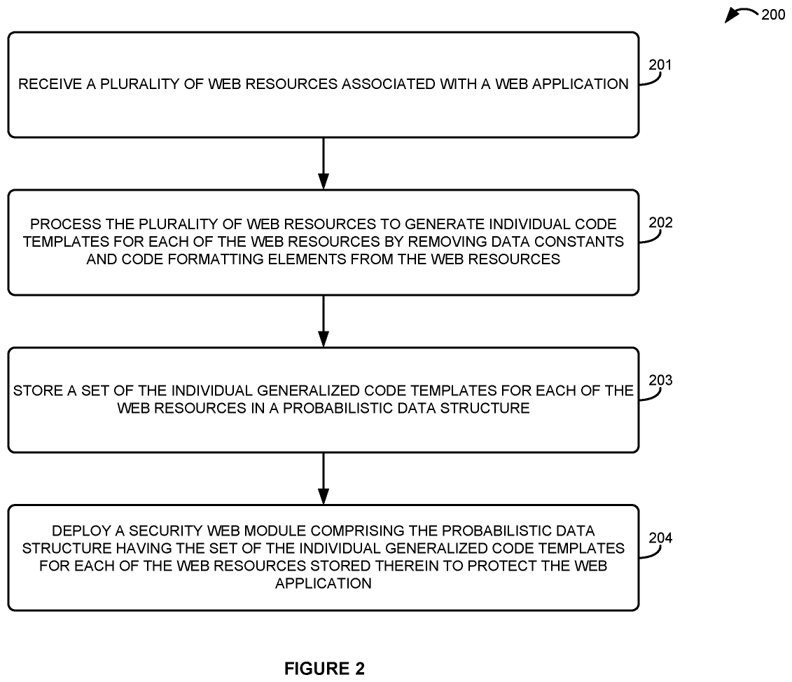

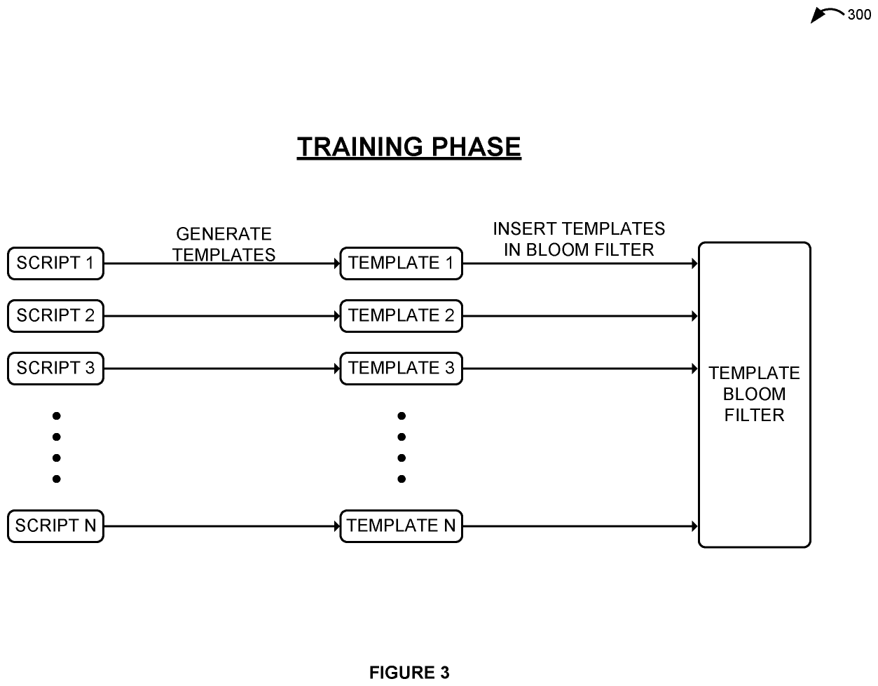

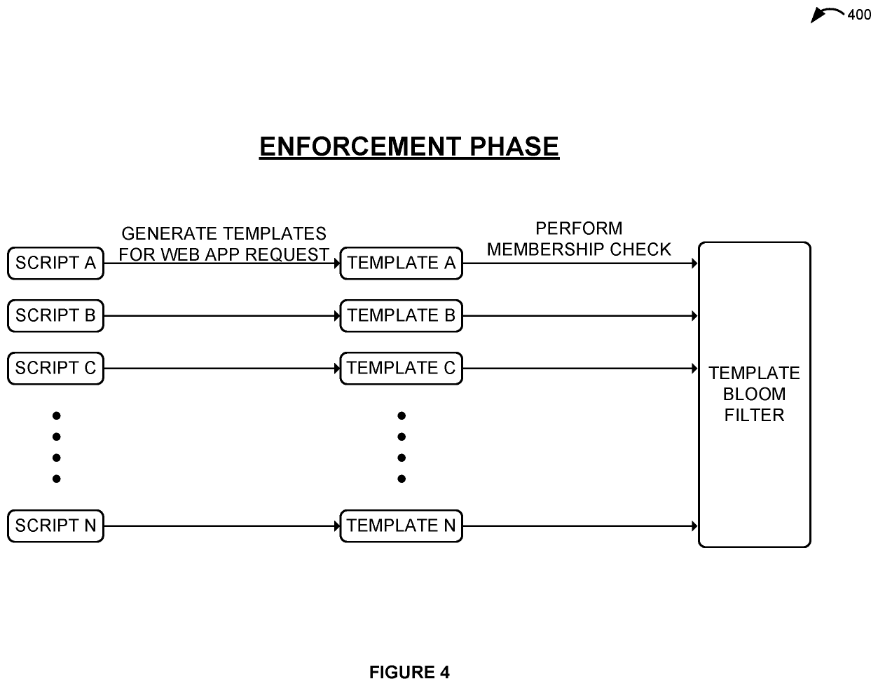

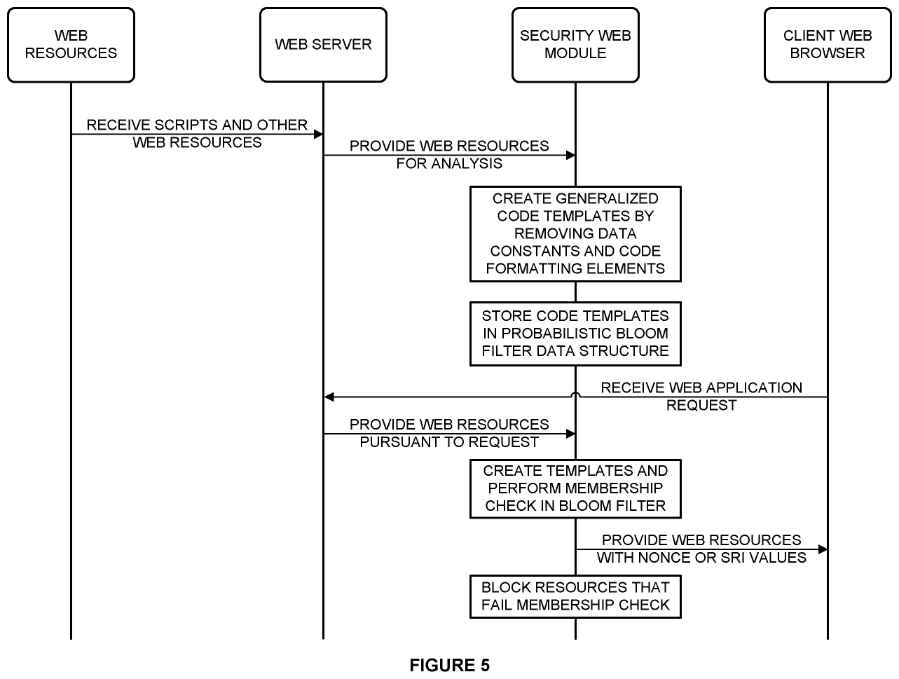

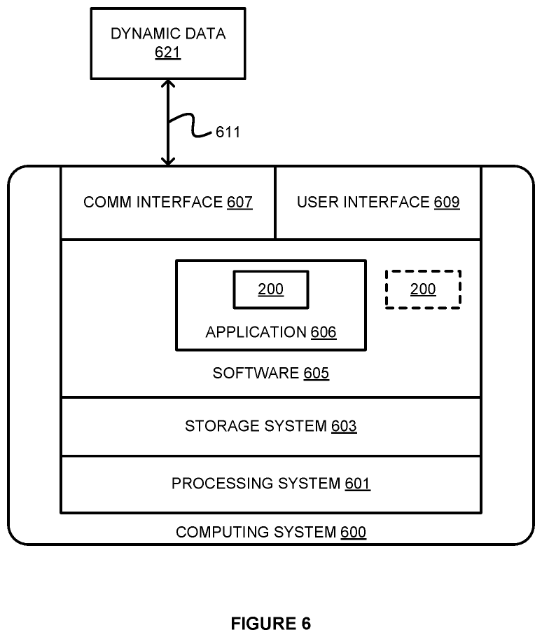

Referring now to the drawings, FIG. 1 illustrates a communication system that may be used to generate individual generalized code templates for web resources. FIG. 2 is a flow diagram that illustrates a template generation process that may be performed by a computing system. FIG. 3 illustrates an exemplary operation of a training phase of a template generation algorithm, while FIG. 4 illustrates an exemplary operation of an enforcement phase to approve or deny scripts at runtime based on a membership check. FIG. 5 is a sequence diagram that illustrates an exemplary operation of a security web module to generate templates for web resources and enforce security policies. Finally, FIG. 6 illustrates an exemplary computing system that may be used to perform any of the template generation processes and operational scenarios described herein.

Turning now to FIG. 1, a block diagram of communication system 100 is illustrated. Communication system 100 includes web resources 110, communication network 120, and computing system 101. Web resources 110 may be provided over communication network 120 via communication link 111, while computing system 101 and communication network 120 communicate over communication link 112. In some examples, computing system 101 could comprise a web server, CDN, reverse proxy, load balancer, client computing system, or any other computing system or network. In at least one implementation, computing system 101 could comprise a system that provides a cloud-based web service. In some implementations, web resources 110 could comprise any resources used in the provision of a web application, such as scripts, code libraries, JavaScript files, and any other web application components, which may be stored on a database or some other data storage system that provides web resources 110 for a web application. In at least one implementation, web resources 110 could be part of an origin web server that provides the web application, which may include internal inline scripts that are embedded into HTML, pages, but web resources 110 could also represent first party web resources of the web application owner that are provided via CDNs and other external data sources. Additionally or alternatively, web resources 110 could also represent external web resources that are provided by third parties, such as advertisers or external libraries, which would also be served by external data sources.

In some implementations, computing system 101 may operate to execute a template generation algorithm on a plurality of web resources 110. The main goal of this algorithm is to generate a code template without performing expensive operations such as lexical analysis (i.e., extracting tokens such as literals, keywords, delimiters, identifiers, etc.), and parsing (i.e., checking if the tokens satisfy the grammar of the language). For example, there are very complex operations such as tokenizing, identifying different forms of language constructs, and creating grammar-based abstract syntax trees, all of which take a lot of time and processing power. Instead of performing any of these costly operations, the template generation algorithm specifically addresses the generalization of data constants in the code. The generalization strategy for template extraction requires a trade-off between false positives and false negatives. Too much generalization can decrease false positives, but would increase false negatives, thereby providing opportunities for attackers to succeed. Too little generalization would have the opposite effect, in that it can improve the security but negatively affect the utility. The generalization strategy for the template generation algorithm disclosed herein is based on removing data constants, which strikes a good balance between the two. As a result, the behavior of the code remains intact, but the data on which the code acts can vary. Automated scripts often require this flexibility to customize the web application. For example, an advertisement serving script may need to initialize marketing URLs specifically targeted based on the end user's profile or preference. This list of URLs may then be embedded into a variable that holds an array of strings, which becomes part of the code of the script, but this list can change periodically, and can also vary for different end users. Accordingly, by removing the constant literal data values from the script to generate the templates, such as the array of advertising URL strings, the behavior of the script is retained, but the data on which the code acts is irrelevant and thus eliminated.

In addition to removing constant literals, the code template representation is also normalized by eliminating the variations caused by styling, indentation, code comments, and other code formatting elements. The templates generated using the above algorithm may be used to apply enforcement policy on the web server. For instance, if a web resource such as a script is encountered pursuant to a client request of a web application, its template can be generated and checked to determine whether the template was seen during the training phase. If the answer is yes, the script can be allowed using nonce or SRI directives. This approach requires storing all templates in the memory for efficient real-time matching. However, this is not memory efficient because the size of a template is usually substantially higher than the size of the script that it represents. This could be optimized by storing only the template hashes and matching the hash values. However, the number of templates could be arbitrarily large, and this may end up increasing the memory footprint to impractical levels at scale. To avoid this problem, the resulting generalized code templates may be stored in a memory-efficient probabilistic data structure, such as a Bloom filter, quotient filter, cuckoo filter, or any other probabilistic data structure that enables encoding a large number of templates using a small amount of constant memory. However, this space efficiency comes at the cost of accuracy because it provides a probabilistic answer to the membership function. If a template is inserted into the filter, it will correctly answer that the template belongs to the filter. However, there is a small probability that it may incorrectly identify a template as a member even if that is not the case. Nonetheless, the data structure allows the tuning of the probability to a small tolerable value, thereby making it practical. With this tradeoff, an attack could be missed with a very small probability, but a benign script would never be blocked, which is crucial in maintaining the utility of the web application. An exemplary implementation for operating a computing system 101 to generate code templates for a plurality of web resources 110 will now be discussed with respect to FIG. 2.

FIG. 2 is a flow diagram that illustrates an operation 200 of communication system 100. The operation 200 shown in FIG. 2 may also be referred to as template generation process 200 herein. The steps of the operation are indicated below parenthetically. The following discussion of operation 200 will proceed with reference to computing system 101 and web resources 110 of FIG. 1 in order to illustrate its operations, but note that the details provided in FIG. 1 are merely exemplary and not intended to limit the scope of process 200 to the specific implementation shown in FIG. 1.

Operation 200 may be employed by computing system 101 to facilitate protection of web application components. As shown in the operational flow of FIG. 2, computing system 101 receives a plurality of web resources 110 associated with a web application (201). In some examples, the web resources 110 could comprise building blocks for constructing web applications, which may be requested by a client to load a webpage. For example, web resources 110 may include JavaScript code, third-party libraries, scripts, style sheets, plugins, tag managers, or any other web application components. In at least one implementation, the plurality of web resources 110 comprise web application scripts. The plurality of web resources 110 may be received by computing system 101 from any source, but are typically received from web servers, CDNs, third-party computing systems, cloud services, or any other data sources that may provide web resources 110 for the web application. In at least one implementation, computing system 101 receives the plurality of web resources 110 pursuant to a training phase to access all valid web resources 110 associated with the web application. In some implementations, the training can be performed in an offline manner by crawling the web application and identifying all the web resources 110 that the web application uses. In some implementations, the training may also be performed in an online environment based on real user traffic. Additionally, in at least one implementation, the training can also be a part of the application development or deployment process. Further, in some implementations the web resources 110 may be received by computing system 101 incrementally and updated over time, so that if a new resource is added or an existing resource is updated, the web resources 110 available to computing system 101 are updated as well.

Computing system 101 processes the plurality of web resources 110 to generate individual generalized code templates for each of the web resources 110 by removing data constants and code formatting elements from the web resources 110 (202). In some implementations, the data constants that are removed comprise any data items in web resources 110 that are literal in value, such as integers, floats, Booleans, strings, or any other type of alphanumeric data values. In at least one implementation, processing the plurality of web resources 110 to generate the individual generalized code templates for each of the web resources 110 by removing the data constants from the web resources 110 comprises removing constant scalar literals from the web resources 110, such as single-value literals like integers, floating types, or strings. In some implementations, the data constants that are removed could also comprise complex literal values, such that processing the plurality of web resources 110 to generate the individual generalized code templates for each of the web resources 110 by removing the data constants from the web resources 110 comprises removing complex data literals from the web resources 110. Some examples of complex data literals that may be removed to generate the individual generalized code templates for each of the web resources 110 could include arrays, structures, and objects. Computing system 101 also removes code formatting elements from web resources 110 to generate the individual generalized code templates for each of the web resources 110. Some examples of code formatting elements include code style, indentations, whitespaces, code comments, and any other code formatting and styling elements that do not effect the execution of the code. For example, in at least one implementation, processing the plurality of web resources 110 to generate the individual generalized code templates for each of the web resources 110 by removing the code formatting elements from the web resources 110 comprises eliminating whitespace and code comments from the web resources 110.

In some implementations, to extract a generalized template representation, two passes over the code of web resources 110 may be performed. In the first pass, literal data constants are removed, such as integer, float, Boolean, and string values, along with the code formatting elements such as indentations and all the whitespaces, code comments, and any other variations caused by styling that do not effect code execution. Note that the patterns for matching literals and comments are mostly generic across different languages and their versions. In the second pass, complex literal data values are removed, such as arrays, structures and objects. This type of complex data also has standard representation applicable across multiple languages. For instance, an array is commonly represented using a list of elements within box brackets (e.g., [1, 2, 3]); a structure is often represented as a list of elements within curly brackets (e.g., {1, “red”, false}); and an object is typically represented using a list of key, value pairs within curly brackets (e.g., {name: ‘John Smith’, age: 27}). Accordingly, after the scalar literal data constants are removed in the first pass, the arrays, structures, and objects would have patterns of the form [,,,,,], {,,,,}, and {:,:,:,}, respectively. In the second pass, these types of patterns in complex data literals may be identified and removed as well. This step may also be applied recursively to remove complex literals that may have nested complex objects. Further, in some implementations a higher degree of generalization may also be achieved by removing a complex data literal even if it includes a variable as an element. Note that when removing data constants from the web resources 110 to generate the individual generalized code templates, the references may be completely eliminated, including any type information for the data values of both scalar and complex literals.

Computing system 101 stores a set of the individual generalized code templates for each of the web resources 110 in a probabilistic data structure (203). In at least one implementation, the probabilistic data structure could comprise a Bloom filter, but other probabilistic data structures could also be used, such as a quotient filter, cuckoo filter, or any other probabilistic data structure. The use of a probabilistic data structure to store the individual generalized code templates for each of the web resources 110 provides memory space efficiency and improved execution speed at runtime for better performance.

Computing system 101 deploys a security web module comprising the probabilistic data structure having the set of the individual generalized code templates for each of the web resources stored therein to protect the web application (204). The security web module comprising the probabilistic data structure is generally deployed to perform enforcement of security policies for the web resources 110 to protect the web application. In some implementations, computing system 101 could deploy the security web module comprising the probabilistic data structure having the set of the individual generalized code templates for each of the web resources 110 stored therein to any web application platform, such as a web server, middleware, reverse proxy, load balancer, CDN, client web browser, client computing system, or any other entity involved in providing the web application to the client. As part of the enforcement, whenever a new web resource is encountered, the security web module may generate its template and check if the template is a member of the probabilistic data structure in some implementations. If the template for the newly encountered resource is a member, the resource may be protected using directives such as nonce and SRI. However, if the template for the newly encountered web resource is not a member, the resource may be blocked by not using the directive, removing the resource from the web application, sending notifications or alerts to the client and/or the web application owner, or some other security measures. For example, in at least one implementation, the security web module may be utilized to enforce security policies for the web application pursuant to a client web application request by generating individual templates for each web resource associated with the client web application request, performing a membership check for the individual templates for each web resource associated with the client web application request by checking whether the individual templates for each web resource are members of the set of the individual generalized code templates in the probabilistic data structure, and applying security measures for any of the individual templates that fail the membership check.

Advantageously, the security techniques disclosed herein provide for the generation of generalized code templates for each of the web resources 110 associated with a web application by removing data constants and code formatting elements from the web resources 110. Further, storage of a multitude of templates is achieved through a memory-efficient probabilistic data structure, which also facilitates a simple membership check to determine whether a web resource is known and therefore benign or unknown and thus possibly malicious, thereby incurring low runtime and memory overhead. Storing the templates in this manner also allows for unknown web resources that are benign variations of known resources, which are necessary to run to preserve the utility of the web application, without negatively impacting security. In addition, the templates that are generated capture generalized representations of web resource code in a language-independent manner, even if there are syntax errors or the implementation language of the code changes. An exemplary operation of a training phase of a template generation algorithm will now be discussed with respect to FIG. 3.

FIG. 3 is a block diagram that illustrates an operation of communication system 300 in an exemplary embodiment. The techniques described below with respect to FIG. 3 could also be executed by the systems of communication system 100 such as computing system 101, and could be combined with operation 200 of FIG. 2 in some implementations.

The deployment steps of the security techniques disclosed herein may include a training phase and an enforcement phase. FIG. 3 describes the training phase of the deployment process. In the training phase, access to all the valid scripts and other web resources is necessary in order to generate the generalized code templates for each of the resources. The training can be performed in an offline manner by crawling the web application and identifying all the resources the web application uses. The training can also be performed in an online environment based on the real user traffic. Additionally, the training can also be a part of the web application development or deployment process.

In this example, templates of each of the scripts associated with a web application are extracted during training. It is possible that multiple scripts have the same template. A probabilistic data structure such as a Bloom filter in this example is created and all of the generated templates are inserted. The Bloom filter can be periodically updated as new valid scripts are added into the web application. This Bloom filter is then deployed for policy enforcement on the web server, CDN, reverse proxy, load balancer, client web browser, or some other computing entity associated with provision of the web application. An exemplary operation of the enforcement phase of the deployment process will now be discussed with respect to FIG. 4.

FIG. 4 is a block diagram that illustrates an operation of communication system 400 in an exemplary embodiment. The techniques described below with respect to FIG. 4 could also be executed by the systems of communication system 100 such as computing system 101, and could be combined with operation 200 of FIG. 2 in some implementations.

As discussed above, the deployment steps of the security techniques disclosed herein may include a training phase and an enforcement phase. FIG. 4 describes the enforcement phase of the deployment process. The enforcement is generally performed via a security web module that is deployed to protect the web application. A module can be specific to the web application platform, such as web server, middleware, reverse proxy, load balancer, CDN, and client web browser. In this example, whenever a new script is encountered pursuant to a web application request, the module generates its template on the fly and checks if the template belongs to the Bloom filter. If the template is a member, the script is protected using directives such as nonce and SRI. For example, a random string or number, called a nonce, can be included inside an HTML, element such as a script or other resource, and then the client web browser verifies whether that random nonce value is the same as the one that was given to it through the HTTP header by the web server. In the case of SRI, a hash of a script or other resource can be specified that creates a digital signature which then becomes part of the security policy, and if the hash matches the actual content received by the client then the client browser can safely load that web resource. However, if the template fails the membership check in the Bloom filter, the script may be blocked by not using the SRI or nonce directives, which will cause the client browser to automatically block the script lacking the nonce or SRI directive, or by simply removing the script from the web application directly, provided the security web module has sufficient access and control to perform the removal itself. Another exemplary operation of the security techniques disclosed herein will now be discussed with respect to FIG. 5.

FIG. 5 is a sequence diagram that illustrates an exemplary operation of a security web module to generate templates for web resources and enforce security policies. The techniques described below with respect to FIG. 5 could also be executed by the systems of communication system 100 such as computing system 101, and could be combined with operation 200 of FIG. 2 in some implementations.

In this example, the security web module is running on the web server, but the security web module could also execute on a CDN, reverse proxy, load balancer, client web browser, or any other communication system or network element involved in the provision of the web application in other examples. Initially, the security web module operates in a training phase to collect web resources associated with the web application to be protected. In some implementations, the training is performed in both an online environment and an offline manner by crawling the web application and identifying all the scripts and other web resources used by the web application. In this example, the web resources are provided by the web server for analysis by the security web module, but note that the web resources could also be received from CDNs and other third-party external data sources in some implementations. The security web module receives the web resources and creates generalized code templates by removing data constants and code formatting elements from the web resources to generate the templates. The security web module then stores the code templates in a probabilistic Bloom filter data structure, which allows for a large number of templates to be encoded using a small amount of constant memory.

Once all of the generalized code templates have been inserted into the Bloom filter, the security web module operates in an enforcement phase to apply security policies for the web resources to protect the web application. Accordingly, when a web application request is received from a client web browser, the web server provides the web resources pursuant to the request. The security web module quickly processes the web resources provided by the web server to create new templates for each of the resources, and performs a membership check for the new templates in the Bloom filter. If the template is a member, the resource is protected using directives such as nonce and SRI and provided to the client web browser, and if the nonce or SRI matches the actual content received by the client then the client browser can safely load that web resource. However, for templates that fail the membership check in the Bloom filter, the security web module blocks those web resources to prevent the client web browser from loading a possibly malicious script. In some examples, the security web module may block the resources by not using the SRI or nonce directives, which will cause the client browser to automatically block those resources lacking the nonce or SRI directive, or by simply removing the resources from the web application directly, provided the security web module has sufficient access and control to perform the removal itself In this manner, the web application is afforded improved security and protection from potentially malicious web resources having cross-site scripting or other code injection attacks.

Now referring back to FIG. 1, computing system 101 may be representative of any computing apparatus, system, or systems on which the techniques disclosed herein or variations thereof may be suitably implemented. Computing system 101 comprises a processing system and communication transceiver. Computing system 101 may also include other components such as a router, server, data storage system, and power supply. Computing system 101 may reside in a single device or may be distributed across multiple devices. Computing system 101 be a discrete system or may be integrated within other systems, including other systems within communication system 100. Some examples of computing system 101 include desktop computers, server computers, cloud computing platforms, and virtual machines, as well as any other type of computing system, variation, or combination thereof. In some examples, computing system 101 could comprise a web server, CDN, reverse proxy, load balancer, network switch, router, switching system, packet gateway, network gateway system, Internet access node, application server, database system, service node, firewall, or some other communication system, including combinations thereof.

Web resources 110 may be provided by any computing apparatus, system, or systems that may connect to another computing system over a communication network. Web resources 110 may be provided by systems that could comprise a data storage system and communication transceiver. Web resources 110 may be provided by systems that could also include other components such as a processing system, router, server, and power supply. Web resources 110 may reside in a single device or may be distributed across multiple devices. Web resources 110 may be provided by a discrete system or may be provided by multiple systems, including other systems within communication system 100. Some examples of systems that may provide web resources 110 include database systems, desktop computers, server computers, cloud computing platforms, and virtual machines, as well as any other type of computing system, variation, or combination thereof.

Communication network 120 could comprise multiple network elements such as routers, gateways, telecommunication switches, servers, processing systems, or other communication equipment and systems for providing communication and data services. In some examples, communication network 120 could comprise wireless communication nodes, telephony switches, Internet routers, network gateways, computer systems, communication links, or some other type of communication equipment, including combinations thereof. Communication network 120 may also comprise optical networks, packet networks, local area networks (LAN), metropolitan area networks (MAN), wide area networks (WAN), or other network topologies, equipment, or systems, including combinations thereof. Communication network 120 may be configured to communicate over wired or wireless communication links. Communication network 120 may be configured to use Internet Protocol (IP), Ethernet, optical networking, wireless protocols, communication signaling, or some other communication format, including combinations thereof. In some examples, communication network 120 includes further access nodes and associated equipment for providing communication services to several computer systems across a large geographic region.

Communication links 111 and 112 use metal, air, space, optical fiber such as glass or plastic, or some other material as the transport medium, including combinations thereof. Communication links 111 and 112 could use various communication protocols, such as IP, Ethernet, telephony, optical networking, hybrid fiber coax (HFC), communication signaling, wireless protocols, or some other communication format, including combinations thereof. Communication links 111 and 112 could be direct links or may include intermediate networks, systems, or devices.

Turning now to FIG. 6, a block diagram is shown that illustrates computing system 600 in an exemplary implementation. Computing system 600 provides an example of computing system 101, or any computing system that may be used to execute template generation process 200 or variations thereof, although computing system 101 could use alternative configurations. Computing system 600 includes processing system 601, storage system 603, software 605, communication interface 607, and user interface 609. User interface 609 comprises display system 608. Software 605 includes application 606 which itself includes template generation process 200. Template generation process 200 may optionally be implemented separately from application 606, as indicated by the dashed line in FIG. 6.

Computing system 600 may be representative of any computing apparatus, system, or systems on which application 606 and template generation process 200 or variations thereof may be suitably implemented. Examples of computing system 600 include mobile computing devices, such as cell phones, tablet computers, laptop computers, notebook computers, and gaming devices, as well as any other type of mobile computing devices and any combination or variation thereof. Note that the features and functionality of computing system 600 may apply as well to desktop computers, server computers, and virtual machines, as well as any other type of computing system, variation, or combination thereof.

Computing system 600 includes processing system 601, storage system 603, software 605, communication interface 607, and user interface 609. Processing system 601 is operatively coupled with storage system 603, communication interface 607, and user interface 609. Processing system 601 loads and executes software 605 from storage system 603. When executed by computing system 600 in general, and processing system 601 in particular, software 605 directs computing system 600 to operate as described herein for template generation process 200 or variations thereof. Computing system 600 may optionally include additional devices, features, or functionality not discussed herein for purposes of brevity.

Referring still to FIG. 6, processing system 601 may comprise a microprocessor and other circuitry that retrieves and executes software 605 from storage system 603. Processing system 601 may be implemented within a single processing device but may also be distributed across multiple processing devices or sub-systems that cooperate in executing program instructions. Examples of processing system 601 include general purpose central processing units, application specific processors, and logic devices, as well as any other type of processing device, combinations, or variations thereof.

Storage system 603 may comprise any computer-readable storage media capable of storing software 605 and readable by processing system 601. Storage system 603 may include volatile and nonvolatile, removable and non-removable media implemented in any method or technology for storage of information, such as computer readable instructions, data structures, program modules, or other data. Storage system 603 may be implemented as a single storage device but may also be implemented across multiple storage devices or sub-systems co-located or distributed relative to each other. Storage system 603 may comprise additional elements, such as a controller, capable of communicating with processing system 601. Examples of storage media include random-access memory, read-only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the computer-readable storage media a propagated signal.

In operation, processing system 601 may load and execute portions of software 605, such as template generation process 200, to operate as described herein for template generation process 200 or variations thereof. Software 605 may be implemented in program instructions and among other functions may, when executed by computing system 600 in general or processing system 601 in particular, direct computing system 600 or processing system 601 to receive a plurality of web resources associated with a web application. Software 605 may further direct computing system 600 or processing system 601 to process the plurality of web resources to generate individual generalized code templates for each of the web resources by removing data constants and code formatting elements from the web resources. In addition, software 605 directs computing system 600 or processing system 601 to store a set of the individual generalized code templates for each of the web resources in a probabilistic data structure. Software 605 may further direct computing system 600 or processing system 601 to deploy a security web module comprising the probabilistic data structure having the set of the individual generalized code templates for each of the web resources stored therein to protect the web application.

Software 605 may include additional processes, programs, or components, such as operating system software or other application software. Examples of operating systems include Windows®, iOS®, and Android®, as well as any other suitable operating system. Software 605 may also comprise firmware or some other form of machine-readable processing instructions executable by processing system 601.

In general, software 605 may, when loaded into processing system 601 and executed, transform computing system 600 overall from a general-purpose computing system into a special-purpose computing system customized to facilitate protection of web application components as described herein for each implementation. For example, encoding software 605 on storage system 603 may transform the physical structure of storage system 603. The specific transformation of the physical structure may depend on various factors in different implementations of this description. Examples of such factors may include, but are not limited to the technology used to implement the storage media of storage system 603 and whether the computer-storage media are characterized as primary or secondary storage.

In some examples, if the computer-storage media are implemented as semiconductor-based memory, software 605 may transform the physical state of the semiconductor memory when the program is encoded therein. For example, software 605 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 600 is generally intended to represent a computing system with which software 605 is deployed and executed in order to implement application 606 and/or template generation process 200 (and variations thereof). However, computing system 600 may also represent any computing system on which software 605 may be staged and from where software 605 may be distributed, transported, downloaded, or otherwise provided to yet another computing system for deployment and execution, or yet additional distribution. For example, computing system 600 could be configured to deploy software 605 over the internet to one or more client computing systems for execution thereon, such as in a cloud-based deployment scenario.

Communication interface 607 may include communication connections and devices that allow for communication between computing system 600 and other computing systems (not shown) or services, over a communication network 611 or collection of networks. In some implementations, communication interface 607 receives dynamic data 621 over communication network 611. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 609 may include a voice input device, a touch input device for receiving a gesture from a user, a motion input device for detecting non-touch gestures and other motions by a user, and other comparable input devices and associated processing elements capable of receiving user input from a user. Output devices such as display system 608, speakers, haptic devices, and other types of output devices may also be included in user interface 609. The aforementioned user input devices are well known in the art and need not be discussed at length here. User interface 609 may also include associated user interface software executable by processing system 601 in support of the various user input and output devices discussed above. Separately or in conjunction with each other and other hardware and software elements, the user interface software and devices may provide a graphical user interface, a natural user interface, or any other kind of user interface. User interface 609 may be omitted in some examples.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a computing system to facilitate protection of web application components, the method comprising:
receiving a plurality of web resources associated with a web application;
processing the plurality of web resources to generate individual generalized code templates for each of the web resources by removing data constants and code formatting elements from the web resources;
storing a set of the individual generalized code templates for each of the web resources in a probabilistic data structure; and
deploying a security web module comprising the probabilistic data structure having the set of the individual generalized code templates for each of the web resources stored therein to protect the web application.

2. The method of claim 1 wherein the security web module is utilized to enforce security policies for the web application pursuant to a client web application request by:
generating individual templates for each web resource associated with the client web application request;
performing a membership check for the individual templates for each web resource associated with the client web application request by checking whether the individual templates for each web resource are members of the set of the individual generalized code templates in the probabilistic data structure; and
applying security measures for any of the individual templates that fail the membership check.

3. The method of claim 1 wherein the plurality of web resources comprise web application scripts.

4. The method of claim 1 wherein the probabilistic data structure comprises a Bloom filter.

5. The method of claim 1 wherein processing the plurality of web resources to generate the individual generalized code templates for each of the web resources by removing the data constants from the web resources comprises removing constant scalar literals from the web resources.

6. The method of claim 1 wherein processing the plurality of web resources to generate the individual generalized code templates for each of the web resources by removing the data constants from the web resources comprises removing complex data literals from the web resources.

7. The method of claim 1 wherein processing the plurality of web resources to generate the individual generalized code templates for each of the web resources by removing the code formatting elements from the web resources comprises eliminating whitespace and code comments from the web resources.

8. One or more computer-readable storage media having program instructions stored thereon to facilitate protection of web application components, wherein the program instructions, when executed by a computing system, direct the computing system to at least:
receive a plurality of web resources associated with a web application;
process the plurality of web resources to generate individual generalized code templates for each of the web resources by removing data constants and code formatting elements from the web resources;
store a set of the individual generalized code templates for each of the web resources in a probabilistic data structure; and
deploy a security web module comprising the probabilistic data structure having the set of the individual generalized code templates for each of the web resources stored therein to protect the web application.

9. The one or more computer-readable storage media of claim 8 wherein the security web module is utilized to enforce security policies for the web application pursuant to a client web application request by:
generating individual templates for each web resource associated with the client web application request;
performing a membership check for the individual templates for each web resource associated with the client web application request by checking whether the individual templates for each web resource are members of the set of the individual generalized code templates in the probabilistic data structure; and
applying security measures for any of the individual templates that fail the membership check.

10. The one or more computer-readable storage media of claim 8 wherein the plurality of web resources comprise web application scripts.

11. The one or more computer-readable storage media of claim 8 wherein the probabilistic data structure comprises a Bloom filter.

12. The one or more computer-readable storage media of claim 8 wherein the program instructions directing the computing system to process the plurality of web resources to generate the individual generalized code templates for each of the web resources by removing the data constants from the web resources comprises the program instructions directing the computing system to remove constant scalar literals from the web resources.

13. The one or more computer-readable storage media of claim 8 wherein the program instructions directing the computing system to process the plurality of web resources to generate the individual generalized code templates for each of the web resources by removing the data constants from the web resources comprises the program instructions directing the computing system to remove complex data literals from the web resources.

14. The one or more computer-readable storage media of claim 8 wherein the program instructions directing the computing system to process the plurality of web resources to generate the individual generalized code templates for each of the web resources by removing the code formatting elements from the web resources comprises the program instructions directing the computing system to eliminate whitespace and code comments from the web resources.

15. An apparatus to facilitate protection of web application components, the apparatus comprising:
one or more computer-readable storage media;
a processing system operatively coupled with the one or more computer-readable storage media; and
program instructions stored on the one or more computer-readable storage media that, when executed by the processing system, direct the processing system to at least:
receive a plurality of web resources associated with a web application;
process the plurality of web resources to generate individual generalized code templates for each of the web resources by removing data constants and code formatting elements from the web resources;
store a set of the individual generalized code templates for each of the web resources in a probabilistic data structure; and
deploy a security web module comprising the probabilistic data structure having the set of the individual generalized code templates for each of the web resources stored therein to protect the web application.

16. The apparatus of claim 15 wherein the security web module is utilized to enforce security policies for the web application pursuant to a client web application request by:
generating individual templates for each web resource associated with the client web application request;
performing a membership check for the individual templates for each web resource associated with the client web application request by checking whether the individual templates for each web resource are members of the set of the individual generalized code templates in the probabilistic data structure; and
applying security measures for any of the individual templates that fail the membership check.

17. The apparatus of claim 15 wherein the plurality of web resources comprise web application scripts.

18. The apparatus of claim 15 wherein the probabilistic data structure comprises a Bloom filter.

19. The apparatus of claim 15 wherein the program instructions directing the processing system to process the plurality of web resources to generate the individual generalized code templates for each of the web resources by removing the data constants from the web resources comprises the program instructions directing the processing system to remove constant scalar literals from the web resources.

20. The apparatus of claim 15 wherein the program instructions directing the processing system to process the plurality of web resources to generate the individual generalized code templates for each of the web resources by removing the data constants from the web resources comprises the program instructions directing the processing system to remove complex data literals from the web resources.
